(19) United States
(12) Patent Application Publication
(10) Pub. No.: US 2010/0115310 A1
(43) Pub. Date: May 6, 2010

(54) DISK ARRAY APPARATUS

(75) Inventors: Satoshi KUBOTA, Kawasaki (JP); Kazuhiko Amano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/684,515

(22) Filed: Jan. 8, 2010

Related U.S. Application Data
(63) Continuation of application No. PCT/JP2007/063901, filed on Jul. 12, 2007.

(51) Int. Cl. G06F 1/32; G06F 11/20

(52) U.S. Cl. 713/320; 714/6; 714/E11.105

(57) ABSTRACT

A disk array apparatus includes: a plurality of storage units for storing data redundantly, the data of the at least one of the storage units being recoverable by the rest of the storage units; and a controller for controlling the storage units to have write data written into redundantly in response to a write command from the exterior, and controlling at least one of the storage units to assume an inactive state under a power saving mode and controlling the rest of the storage units to produce read out data in response to a read command from the exterior during the power saving mode.

### CROSS-REFERENCE TO RELATED APPLICATION

This application is a continuation application of the International Patent Application No. PCT/JP2007/063901, filed on Jul. 12, 2007 the entire contents of which are incorporated herein by reference.

### FIELD

The embodiment discussed herein is related to a disk array apparatus.

### BACKGROUND

A disk array apparatus includes plural storage units in a redundant configuration in order to increase the possibility of preservation of stored data. A disk array apparatus includes plural disk devices. RAID (redundant array of independent disks) is a technology for managing plural disk devices. RAID is a data recording scheme for increasing the reliability of preservation of data with independent plural disk devices in a redundant configuration. The disk devices included in a RAID are referred to as member disks.

Operating a disk array apparatus requires power. In recent years, it has been increasingly important to reduce power consumed by disk array apparatuses. In order to reduce such power consumption, there is provided a technology that reduces power consumed by redundant member disk devices if an access from a host apparatus is not detected for a predetermined time or time longer than that.

For example, in a system providing a data distribution service, a host apparatus issues many data READ commands. However, according to a technology in the past, when a host apparatus accesses a disk array apparatus within a predetermined period of time, a power saving mode is not executed in the disk array apparatus. Thus, it is difficult to sufficiently reduce the power consumed by the disk array apparatus.

Japanese Laid-open Patent Publication No. 2005-228288 and Japanese Laid-open Patent Publication No. 2000-293314 are examples of technologies in the past.

### SUMMARY

According to an aspect of the invention, a disk array apparatus includes: a plurality of storage units for storing data redundantly, the data of the at least one of the storage units being recoverable by the rest of the storage units; and a controller for controlling the storage units to have write data written into redundantly in response to a write command from the exterior, and controlling at least one of the storage units to assume an inactive state under a power saving mode and controlling the rest of the storage units to produce read out data in response to a read command from the exterior during the power saving mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a storage system 1 of this embodiment.

FIG. 2 is a configuration example of a RAID group table 50.

FIG. 3 is a configuration example of a LUN table 60.

FIG. 4 is a flowchart of processing to be performed when a READ command is received.

FIG. 5 is a flowchart of processing to be performed when a WRITE command is received.

FIG. 6 is a flowchart of power-saving-mode determining processing.

FIG. 7 is a flowchart of shifting processing of shifting to the power saving mode.

FIG. 8 is a flowchart of processing of shifting to the normal mode.

FIG. 9 is a flowchart of processing to be performed when a failure is detected.

FIG. 10 is a flowchart of processing to be added to FIG. 6 if a failing disk device is detected.

FIG. 11 is a flowchart of processing changed from FIG. 7 if a failing disk device is detected.

### DESCRIPTION OF EMBODIMENT

An embodiment of the present invention will be described below. It is an object of the present embodiment to provide a disk array apparatus in a system in which data READ commands are frequently issued by a host apparatus, where power consumed by the disk array apparatus is reduced. According to the present embodiment, there is provided a disk array apparatus in a system in which data READ commands are frequently issued between a host apparatus and the disk array apparatus, where power consumed by the disk array apparatus is reduced.

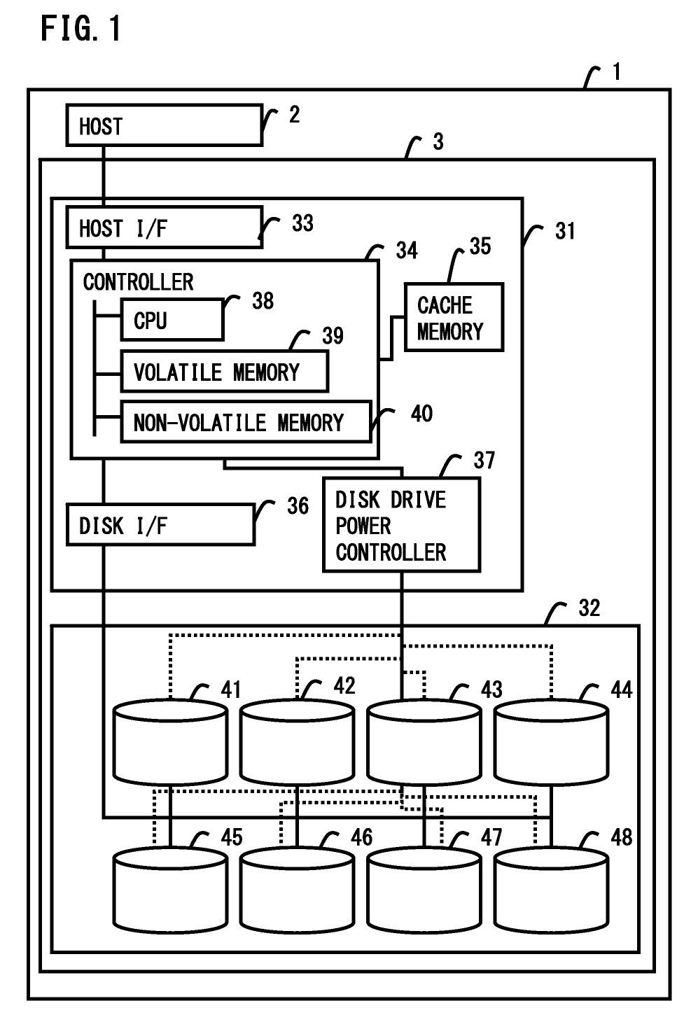

FIG. 1 is a configuration diagram of a storage system 1 of this embodiment. The storage system 1 includes a host apparatus (or host computer) 2 and a disk array apparatus 3.

In the host apparatus (exterior) 2, various kinds of application software operate. The host apparatus 2 may, for example, transmit an instruction to read data required by application software to the disk array apparatus 3 and/or transmit an instruction to write data created by application software to the disk array apparatus 3.

The disk array apparatus 3 performs processing of storing data transmitted from the host apparatus 2 to a disk device in a disk device storage portion 32 and/or processing of reading the stored data in response to a request from the host apparatus 2.

The disk array apparatus 3 of this embodiment is connected to the host 2 over a network. The disk array apparatus 3 of this embodiment has a managing portion 31 that manages plural disk devices and the disk device storage portion 32 that stores plural disk devices.

The managing portion 31 has a host interface (which may be abbreviated to host I/F) 33, a control module (which may be called controller) 34, a cache memory 35, a disk interface (which may be abbreviated to disk I/F) 36, and a disk power supply control module (which may be called disk drive power controller) 37.

The host interface 33 is an interface that connects between the host apparatus 2 and the control module 34.

The control module 34 has a CPU 38, a volatile memory 39, and a non-volatile memory 40. The control module 34 controls the entire disk array apparatus 3. For example, the control module 34 may perform control over the communication with the host apparatus 2, control over the cache memory 35 that temporarily stores data received from the host apparatus 2, and control over a RAID including plural disk devices in the disk device storage portion 32. The control module 34 is connected to the host IF 33, and the disk IF 36 within the disk array apparatus 3. The CPU 38 executes a control program for managing plural disk devices 41 to 48. In the volatile memory 39, the content stored therein is lost if the power supply shuts down. The volatile memory 39 is a storage area where the control program is expanded. The volatile memory 39 further temporarily stores various information output as a result of the execution of the control program by the CPU 38. The volatile memory 39 further stores a RAID group table 50 and a logical unit number (which will be abbreviated to LUN hereinafter) table 60. The non-volatile memory 40 holds the contents stored therein even if power supply shuts down. The non-volatile memory 40 stores the control program. The control module 34 or the managing portion 31 may control the disk devices to have write data written into redundantly in response to a write command from the host apparatus 2. The control module 34 or the managing portion 31 may control at least one of the disk devices to assume an inactive state to reduce power consumption under a power saving mode. The control module 34 or the managing portion 31 may control the rest of the disk devices to produce read out data in response to a read command from the host apparatus 2 during the power saving mode. The control module 34 or the managing portion 31 may control all the disk devices to produce read out data in response to a read command from the exterior under a normal mode. The control module 34 or the managing portion 31 may control the at least one of the disk devices to assume the inactive state to reduce power consumption under the power saving mode when an amount of write commands stores in the cache memory 35 is less than a predetermined amount. The control module 34 or the managing portion 31 may detect a write command from the host apparatus 2 to the disk array apparatus 3. The control module 34 or the managing portion 31 may control the disk devices to have write data written into redundantly in response to a write command from the host apparatus 2 after the disk devices have been active state. The control module 34 or the managing portion 31 may control either the disk device which has been set the power saving mode to assume the inactive state or the disk device which has been set the normal mode to assume an active state.

The control module 34 or the managing portion 31 may execute a process including: controlling write data to be written into the first and the second disk devices in duplicate in response to a write command from the host apparatus 2, controlling at least one of the first and second disk devices to produce read out data in response to a read command by the host apparatus 2 while controlling the other of the first and second disk devices to assume an inactive state to reduce power consumption, and controlling the cache memory 35 to temporarily store write data that is to be written into the first and second disk devices in response to a write command, and while at least a part of the write data remains in the cache memory 35 yet to be written into the first and second disk devices, controlling one of the disk devices to assume an inactive state to reduce power consumption and controlling the other of the first and second disk devices to produce read out data in response to a read command subsequently issued by the host apparatus 2.

The cache memory 35 is a storage area for temporarily storing a WRITE command received from the host. The disk IF 36 is an interface that connects between the control module 34 and the disk device storage portion 32. The disk power supply control module 37 controls the state of power supply of the plural disk devices 41 to 48 in the disk device storage portion 32. The cache memory 35 may store the data to be written into the disk device when the disk device is set to the power saving mode.

The disk device storage portion 32 has the plural disk devices (storage units) 41, 42, 43, 44, 45, 46, 47, and 48. Each of the disk devices 41 to 48 may store data in accordance with the instructions from the control module 34 or output data to the control module 34 in accordance with the instructions from the control module 34. The plural disk devices 41 to 48 in the disk apparatus storage portion 32 function as a RAID. The RAID level of this embodiment is 1+0. RAID level 1+0 is a structure hierarchically combining a RAID level 1 and a RAID level 0. RAID level 1 is mirroring. RAID level 0 is striping. RAID level 1+0 has plural mirrored sets of RAID level 1. By handling the plural mirrored sets as a unit, RAID level 0 stripes the data. Here, a redundant configuration is important, and other RAID levels such as RAID levels 1 and 5 may also applicable. Each of the plural disk devices may store data redundantly. The data of the at least one of the disk devices may be recoverable by the rest of the disk devices. A first and a second disk devices for redundantly store data and duplicate data, respectively.

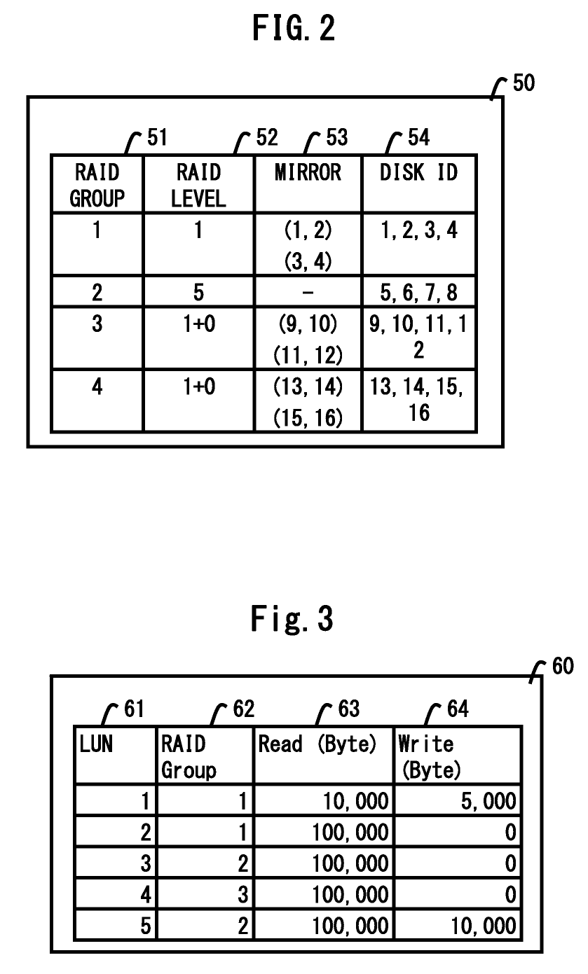

Next, a table to be expanded on the volatile memory 39 will be described. The disk array apparatus 3 may have plural RAID groups. The disk array apparatus 3 has a table for managing the plural RAID groups. FIG. 2 is a RAID group table 50 for managing a RAID group. The RAID group table 50 has, as column items, RAID group information 51 that identifies a RAID group, RAID level information 52 that identifies the RAID level of a RAID group, mirror information 53 that identifies a disk device in a mirroring relationship among member disks in a RAID group, and a disk ID information 54 that identifies the disk device corresponding to a member disk in a RAID group. The disk array apparatus 3 manages records by handling each of the column items as one set.

The disk array apparatus 3 has a table that has correspondence between a LUN and a RAID group. According to this embodiment, a LUN is an identification number for identifying a RAID group if the disk array apparatus 3 has plural RAID groups. The host apparatus 2 identifies data to be read or written by a LUN. FIG. 3 illustrates a LUN table 60 having correspondence between a LUN and a RAID group. The LUN table 60 has, as column items, LUN information 61 for identifying a LUN, RAID group information 62 that identifies a RAID group corresponding to a LUN, READ information 63 that stores the amount of READ data for a READ command from the host apparatus 2, and WRITE information 64 that stores the amount of WRITE data for a WRITE command from the host apparatus 2. The disk array apparatus 3 manages records by handling each of the column items as one set.

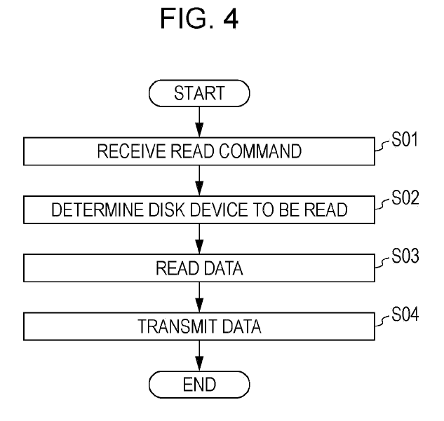

Next, READ processing in the storage system 1 will be described. FIG. 4 is a flowchart of processing to be performed when the disk array apparatus 3 receives a READ command.

The control module 34 in the disk array apparatus 3 receives a READ command from the host apparatus 2 (S01). The READ command has LUN information and address information on data to be read. The control module 34 determines a disk device to be read (S02). If the target data of the READ command is stored in the cache memory 35, the control module 34 reads the target data from the cache memory 35.

For example, the control module 34 refers to the LUN table 60 to identify a RAID group to which the identified LUN belongs. Then, the control module 34 reads data from the disk device belonging to the RAID group corresponding to the address storing the data (S03). In order to perform the READ processing on the RAID group in a power saving mode, the control module 34 identifies a disk device in operation among redundant member disks. The control module 34 then reads data from the identified disk device in operation. The control module 34 transmits the read data to the host apparatus 2 (S04). The control module 34 stores the amount of read data to the READ information 63 in the record corresponding to the LUN on the LUN table 60.

Now, modes will be defined. The disk devices according to this embodiment have two kinds of mode of a normal mode and a power saving mode. The normal mode is a state where the disk device can perform processing for reading or writing data from or to a recording medium. The power saving mode is a state that recover to the state where processing for reading or writing data from or to a recording medium can be performed in order to perform the processing. In the power saving mode, a part of the functions of the disk device stops. For example, it is a state where the power shuts down. Alternatively, it is a state where the control substrate of the disk device is powered on, but the recording medium is not rotating. The disk device in the normal mode can read data. The disk device in the power saving mode consumes a less amount of power than the normal mode.

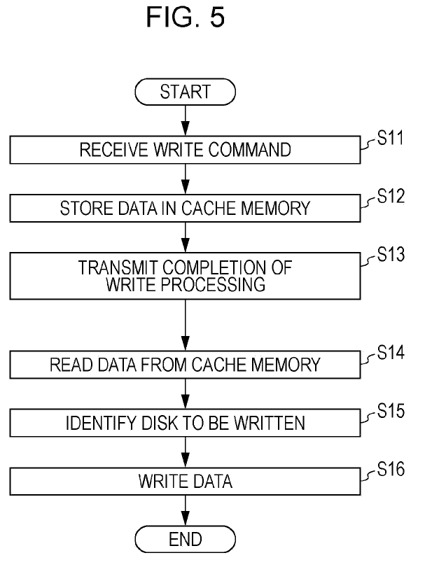

Next, WRITE processing in the storage system 1 will be described. FIG. 5 is a flowchart of processing to be performed when the disk array apparatus 3 receives a WRITE command.

The control module 34 in the disk array apparatus 3 receives a WRITE command from the host apparatus 2 (S11). The WRITE command has the data to be stored, a LUN to which the data are to be stored and address information. The control module 34 stores the data to be stored, a LUN to which the data are to be store and address information received in S11 to the cache memory 35 (S12). The control module 34 transmits the completion of the WRITE processing to the host apparatus 2 (S13). This means that, at the point in time in S13, the data relating to the WRITE command received from the host apparatus 2 have not been written in the disk device. The control module 34 stores the amount of data stored in the cache memory 35 to the WRITE information 64 in the record corresponding to the LUN on the LUN table 60.

The control module 34 performs processing of storing the data stored in the cache memory 35 to a disk device, as required. The control module 34 reads the data to be written to a disk device, and the address information of the destination to which the data is to be written from the cache memory 35 (S14). The control module 34 identifies the disk device to which the data are to be written from the address information (S15). The control module 34 writes the data to the target disk device (S16).

In this way, the disk array apparatus 3 performs the WRITE processing. The processing in S11 to S13 and the processing in S14 to S16 to be performed by the control module 34 are not required to perform in series. The disk array apparatus 3 performs the processing of writing the data stored in the cache memory 35 to a disk device at a proper time.

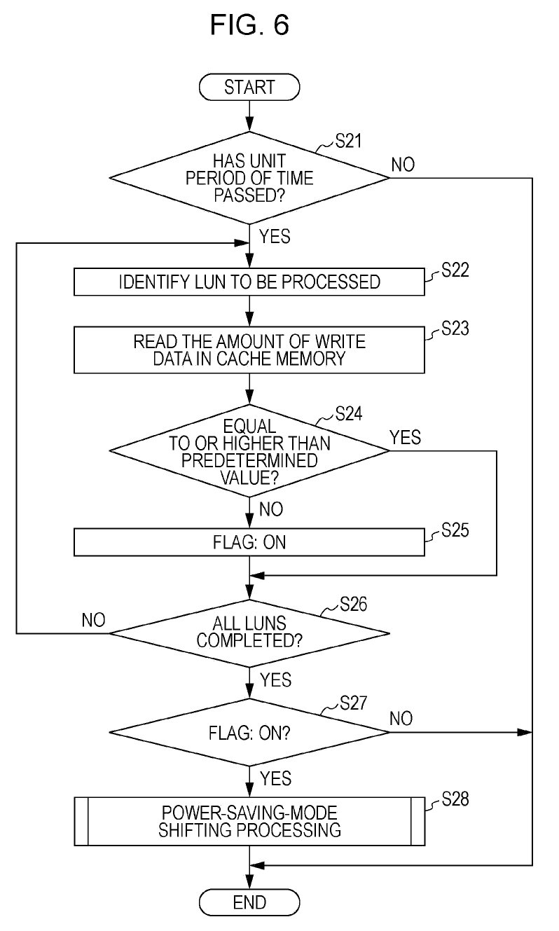

Next, processing of switching to the power saving mode in the storage system 1 will be described. FIG. 6 illustrates a flowchart of power-saving-mode determining processing by the disk array apparatus 3. In the power-saving-mode determining processing, the disk array apparatus 3 determines whether a disk device may be switched to the power saving mode or not.

The control module 34 determines whether a unit time has passed or not (S21). The processing of switching a disk device to the power saving mode by the control module 34 may be defined to start at various times. For example, the control module 34 performs WRITE-BACK processing on its managing disk device finally and then starts a timer. When a predetermined period of time has passed in the timer, the control module 34 starts the processing of switching the disk device to the power saving mode. Alternatively, the control module 34 may start the processing of switching to the power saving mode every lapse of a unit period of time.

The control module 34 identifies a LUN to be processing (S22). The control module 34 reads the amount of data temporarily stored in the cache memory 35 (S23). The control module 34 reads the WRITE information 64 on the LUN table 60. In general, the data temporarily stored in the cache memory 35 undergo the WRITE-BACK processing. The cache memory 35 can store data fast, but the storage area is limited. For that reason, the control module 34 determines whether the amount of data stored in the cache memory 35 is equal to or higher than a predetermined amount of data (which will just be called predetermined amount) or not. The predetermined amount is determined as required in accordance with the size of the storable area in the cache memory 35 in the disk array apparatus 3 or the usage of an application to be handled by the host apparatus 2 or storage system 1. For example, when a high amount of data is stored in the cache memory 35 though it is in a system in which data are frequently updated, the system may become instable. On the other hand, in a usage in a system in which the host apparatus 2 mainly performs processing of reading data and rarely performs processing of writing data to a disk device, the possibility that system will be instable is low even though a high amount of data is stored in the cache memory 35. The system in which the processing of reading data is mainly performed and the processing of writing data to a disk device is rarely performed may be a contents distribution server, for example. In a contents distribution server, after the contents (data) to be transmitted are stored in a disk device, reading the contents is the main processing. On the other hand, a contents distribution server securely protect the stored contents. The contents distribution server stores the contents redundantly in a RAID in order to securely protect contents. The contents distribution server may be, for example, a video distribution server or music distribution server.

The control module 34 determines whether the amount of data to be temporarily stored in the cache memory 35 is equal to or higher than a predetermined value or not (S24). For example, the control module 34 determines it by comparing a predetermined threshold value (which will just be called predetermined value) and the amount of data in the WRITE information 64 on the LUN table 60. If it is determined in S24 that it is not equal to or higher than predetermined value (No in S24), the control module 34 changes the flag for performing processing of shifting a disk device to the power saving mode to the on-state (S25). On the other hand, if it is determined in S24 that it is equal to or higher than the predetermined value (Yes in S24), the control module 34 ends the processing. Since whether the control module 34 starts the execution of the WRITE-BACK processing or not is separate from the processing of shifting to the power saving mode, the description will be omitted in the description of this embodiment.

The control module 34 performs the processing in S22 to S25 until all of the LUNs of the disk array apparatus 3 are determined (No in S26). On the other hand, if the control module 34 determines all of the LUNs of the disk array apparatus 3 (Yes in S26), the control module 34 determines whether the flag has the on-state or not (S27). If the flag has the on-state (Yes in S27), it means that there is a LUN satisfying the condition for shifting to the power saving mode. Thus, the control module 34 performs the power saving mode shifting processing (S28). On the other hand, if the flag has the off-state (No in S27), it means that there is no LUNs satisfying the condition for shifting to the power saving mode. Thus, the control module 34 ends the processing.

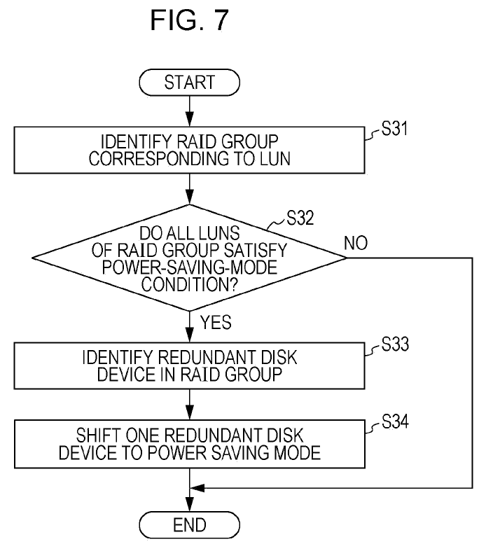

Next, there will be described the processing for switching to the power saving mode in the storage system 1 in S28. FIG. 7 is a flowchart of shifting processing of shifting to the power saving mode.

The control module 34 identifies the RAID group corresponding to a LUN (S31).

One RAID group may be accessed by plural LUNs. In that case, the control module 34 determines whether all LUNs accessing to the RAID group satisfies the condition for shifting to the power saving mode or not (S32). The control module 34 determines whether the WRITE information 64 on all LUNs belonging to the RAID group is equal to or higher than a threshold value or not. If the LUNs in the RAID group do not satisfy the condition for shifting to the power saving mode, it means that a predetermined number or higher of WRITE commands are executed to the RAID group within a unit time. When a predetermined number or higher of WRITE commands are executed but the RAID group is shifted to the power saving mode, the storage area of the cache memory 35 is compressed. Thus, the operation by the disk array apparatus 3 becomes instable.

If all of the LUNs do not satisfy the condition for shifting to the power saving mode (No in S32), the control module 34 is disabled to shift the RAID group to the power saving mode. Thus, the control module 34 ends the processing. On the other hand, if all of the LUNs satisfy the condition for shifting to the power saving mode (Yes in S32), the control module 34 identifies a disk device in a redundant relationship among the member disks included in the RAID group (S33). The control module 34 identifies the LUN information 61 from the current target LUN. The control module 34 identifies the RAID group information 62 from the LUN information 61. The control module 34 identifies the RAID group 51 from the RAID group information 62 and then identifies the disk information 54.

In S32, multiple kinds of power saving mode may be set. The power saving mode may include the settings of, for example, a first stage of stopping the rotation of the motor of a disk device and a second stage of stopping the rotation of the motor of the disk device and also stopping the electrical processing by the control substrate of the disk device. A manager may set in advance a condition for satisfying the first stage and a condition for satisfying a second stage. The conditions may depend on, for example, the amount of data requiring WRITE-BACK processing for each unit time to be stored in the cache memory. In this case, the threshold value for the amount of data for shifting to the first stage of the power saving mode is larger than the threshold value for the amount of data for shifting to the second stage of the power saving mode. The conditions may depend on the length of the time with a fixed Write Back threshold value (which is a unit amount of data). In this case, the threshold value for the time for shifting to the first stage of the power saving mode is lower than the threshold value for the time for shifting to the second stage of the power saving mode. This is because there is a lower possibility that the second stage of the power saving mode will recover to the normal mode than the first stage of the power saving mode.

If all LUNs of the RAID group satisfy the condition for the first stage, the control module 34 performs the processing of shifting to the first stage of the power saving mode. If all LUNs of the RAID group satisfy the condition for the second stage, the control module 34 performs the processing of shifting to the second stage of the power saving mode. The second stage of the power saving mode in which the electrical processing by the control substrate of the disk device is stopped and the rotation of the motor is stopped has a higher effect of power saving than the first stage of the power saving mode in which the rotation of the motor is stopped. However, the second stage of the power saving mode requires a lot of time for recovering to the normal mode by the disk device. Dividing the power saving mode into plural stages can increase the effect of power saving.

For example, the disk devices stored in the disk device storage portion 32 in FIG. 1 have a RAID 1+0 configuration and have the following relationships. The disk device 41 and the disk device 45 have a relationship of mirroring 1, the disk device 42 and the disk device 46 have a relationship of mirroring 2, the disk device 43 and the disk device 47 have a relationship of mirroring 3, and the disk device 44 and the disk device 48 have a relationship of mirroring 4. The mirroring 1, mirroring 2, mirroring 3, and mirroring 4 have a striping relationship. In this case, since the disk device 41 and the disk device 45, the disk device 42 and the disk device 46, the disk device 43 and the disk device 47, and the disk device 44 and the disk device 48 have mirroring configurations, they have redundant relationships. The mirroring relationships may be established not only between two disk devices but also three or more disk devices.

The control module 34 shifts one of the disk devices in a redundant relationship to the power saving mode (S34). The disk device to be shifted to the power saving mode is determined in accordance with the redundancy of the RAID. The redundancy of a RAID is fixed in accordance with the RAID levels. Thus, the control module 34 acquires the redundancy of a RAID from the level information 52 on the RAID group table 50. The redundant configuration is acquired from the mirror information 53 on the RAID group table 50. The control module 34 holds in advance, for example, the information on the disk device to be shifted to the power saving mode between/among the disk devices in a redundant relationship. Alternatively, the control module 34 may switch the disk device to be shifted to the power saving mode upon every shift from the normal mode to the power saving mode.

The control module 34 transmits information on the disk device to be shifted to the power saving mode and type information of the power saving mode to the disk power supply control module 37. The disk power supply control module 37 switches the target disk device to the power saving mode.

Next, there will be described the WRITE processing in the power saving mode in the storage system 1. Writing data to a disk device is not allowed in the power saving mode. Thus, the control module 34 is disabled to perform the WRITE-BACK processing. So, the control module 34 only performs the processing in S11 to S13 in FIG. 5. After the disk device in the RAID group to be written is shifted from the power saving mode to the normal mode, the control module 34 performs the WRITE-BACK processing in S14 to S16. The control module 34 stores the amount of data stored in the cache memory 35 to the WRITE information 64 in the record corresponding to the LUN on the LUN table 60.

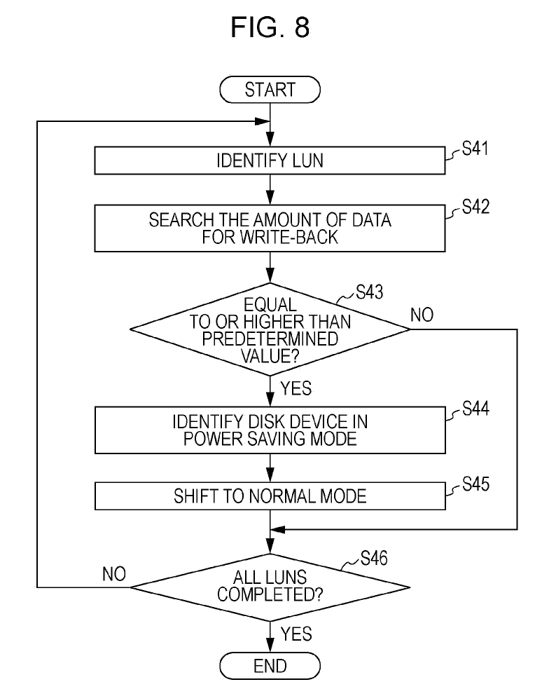

Next, there will be described the recovery processing from the power saving mode in the storage system 1. FIG. 8 is a flowchart of processing of shifting to the normal mode.

The control module 34 may start the processing in FIG. 8 every lapse of a predetermined time. Alternatively, the control module 34 may store the amount of the target data in the WRITE command, and if it is equal to or higher than a predetermined amount of target data of WRITE commands, the processing in FIG. 8 may be started. The time or the amount of the target data of WRITE commands may be defined by a manager in accordance with the types of application to be handled by the storage system 1 and/or the size of the area of the cache memory 35.

The control module 34 identifies a LUN to perform the processing in S42 and subsequent steps (S41). The control module 34 detects the amount of data requiring the WRITE-BACK processing, which is stored in the cache memory 35 corresponding to the LUN from the WRITE information 64 on the LUN table 60 (S42). The control module 34 determines whether the amount of target data requiring the WRITE-BACK processing in the LUN is equal to or higher than a predetermined value or not (S43). If the amount of data is lower than the predetermined value (No in S43), the control module 34 moves to the processing in S46 in order to keep the power saving mode. On the other hand, if the amount of data is equal to or hither than the predetermined value (No in S43), the control module 34 performs processing for shifting the disk device corresponding to the LUN to the normal mode.

The processing for shifting the disk device to the normal mode is performed in S44 and S45. The control module 34 first identifies the disk device in the power saving mode (S44). The control module 34 may identify it from, for example, the mirror information 53 and preset information on the disk device to be shifted to the power saving mode. The control module 34 shifts the disk device identified in S44 to the normal mode (S45). The control module 34 outputs an instruction to shift the target disk device to the normal mode to the disk power supply control module 37. The disk power supply control module 37 shifts the target disk device to the normal mode.

Next, the control module 34 determines whether the processing has completed on all of the LUNs or not (S47). Until the processing on all of the LUNs completes (No in S47), the control module 34 performs the processing from S41. If the processing on all of the LUNs completes (Yes in S47), the control module 34 ends the processing.

Next, there will be described the processing to be performed when the control module 34 detects a failure in a disk device in operation if one of redundant disk devices is in the power saving mode. When a disk device in operation fails, the control module 34 change another redundant disk device from the power saving mode to the normal mode.

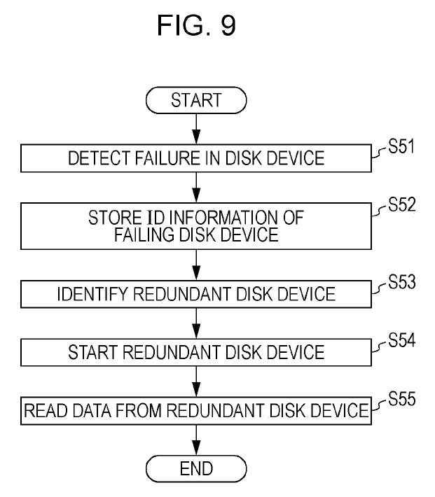

FIG. 9 is a flowchart of processing to be performed when the control module 34 detects a failure in a disk device. The control module 34 detects a failure in a disk device in operation in the normal mode (S51). The control module 34 stores the failing disk device (S52). The control module 34 identifies a disk device in a redundant relationship with the disk device the failure of which has been detected (S53). More specifically, the control module 34 identifies a disk device in a redundant relationship from the disk device the failure of which has been detected and the mirror information 53 on the RAID group table 50. The control module 34 starts the disk device in the redundant relationship (S54). The control module 34 reads data from the disk device in the redundant relationship (S55). This processing allows the disk array apparatus 3 to transmit data to the host 2 even when a redundant disk device in operation has a failure. The disk device the failure of which has been detected is replaced separately.

The processing of shifting to the power saving mode to be performed by the control module 34 when a failing disk device is detected is performed as follows:

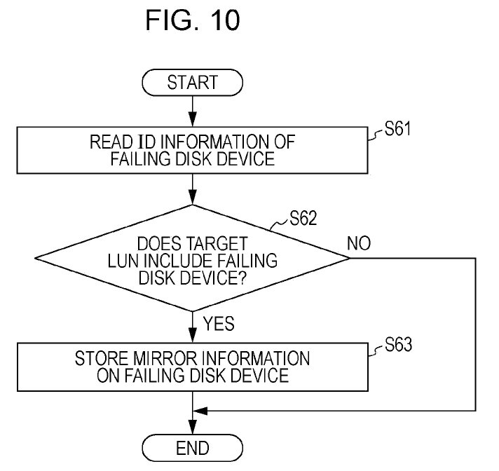

When the control module 34 determines whether it is possible to shift to the power saving mode or not, the control module 34 also determines whether any redundant disk device, which can be shifted to the power saving mode, in the RAID group has a failure or not. For example, the control module 34 may determine whether any redundant disk device has a failure or not between S22 and S23 in the flowchart in FIG. 6. FIG. 10 is a flowchart of processing to be added to FIG. 6 if a failing disk device is detected.

The control module 34 reads the identification number of the failing disk device stored in S52 in FIG. 9 (S61). The control module 34 determines whether the identification number of the disk device included in the RAID group corresponding to the LUN identified by the processing in S22 in FIG. 6 agrees with that of the failing disk device in S61 or not (S62).

If no disk devices in the RAID group have a failure (No in S62), the control module 34 determines whether other conditions for shifting to the power saving mode in and subsequent to S23 in FIG. 6 are satisfied or not. On the other hand, if some disk device in the RAID group has a failure (Yes in S62), the control module 34 determines not to shift to the power saving mode (S63). The control module 34 identifies and stores the disk devices in a mirroring relationship with the failing disk device from the mirror information 53.

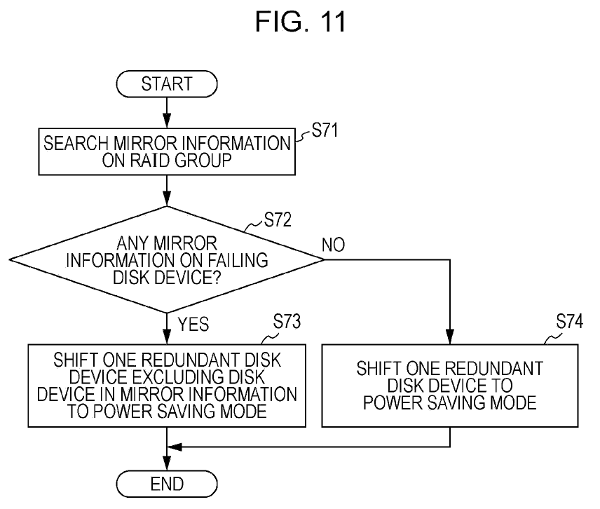

If a redundant disk device within the RAID group has a failure, the control module 34 performs the processing of shifting to the power saving mode as follows: Instead of S33 and S34 in the flowchart in FIG. 7, the control module 34 performs the following processing. FIG. 11 is a flowchart of processing changed from FIG. 7 if a failing disk device is detected.

If all LUNs in the RAID group satisfy the condition for shifting to the power saving mode in S32 in FIG. 7 (Yes in S32), the control module 34 retrieves the mirror information corresponding to the target RAID group of the processing (S71). The control module 34 compares the mirror information 53 of the target RAID group information 51 and the mirror information stored in S63 in FIG. 10 (S72).

If the target RAID group contains the mirror information on the failing disk device (Yes in S72), the control module 34 shifts one redundant disk device excluding the disk device included in the retrieved mirror information to the power saving mode (S73). On the other hand, if the target RAID group does not contain the mirror information including the failing disk device (No in S72), the control module 34 shifts the one redundant disk device to the power saving mode (S74).

This allows the disk array apparatus 3 to shift the disk devices only excluding a failing disk device to the power saving mode if a failing disk device is detected. When the disk device the failure of which has been detected is replaced by a disk device and the failure is eliminated, for example, the control module 34 updates the ID information of the failing disk device stored in S52 and the mirror information on the failing disk device in S63.

This allows the disk array apparatus 3 to properly shift the disk devices with accesses in the disk array apparatus 3 to the power saving mode.

According to this embodiment, the control module 34 determines every time whether a LUN satisfies the condition for shifting to the power saving mode or not. However, for example, a table may store state information on the power saving mode of LUNs and information on whether the shift to the power saving mode is allowed or not. The control module 34 determines it every time, so the control module 34 is not required to define the storage area for storing the state information on the power saving mode of LUNs and information on whether the shift to the power saving mode is allowed or not.

This can increase the effect of the power saving in servers in usages that frequently perform processing of reading data stored in disk devices and rarely perform processing of writing data to disk devices. Examples of the servers in usages that frequently perform processing of reading data stored in disk devices and rarely perform processing of writing data to disk devices may be a server that distributes contents, such as a video distribution server and a music distribution server.

### INDUSTRIAL APPLICABILITY

The present invention is applicable to a disk array apparatus that reads and writes data in accordance with the instructions from a host apparatus. All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A storage apparatus comprising:
a plurality of storage units for storing data redundantly, the data of at least one of the storage units being recoverable by the rest of the storage units; and
a controller for controlling the storage units to have write data written into redundantly in response to a write command from the exterior, and controlling at least one of the storage units to assume an inactive state under a power saving mode and controlling the rest of the storage units to produce read out data in response to a read command from the exterior during the power saving mode.

2. The disk array apparatus according to claim 1, wherein the controller controls all the storage units to produce read out data in response to a read command from the exterior under a normal mode.

3. The disk array apparatus according to claim 1, further comprising a memory for storing data to be written into the storage unit.

4. The disk array apparatus according to claim 3, wherein the memory stores the data to be written into the storage unit when the storage unit is set to the power saving mode.

5. The disk array apparatus according to claim 2, wherein the controller controls the at least one of the storage units to assume the inactive state to reduce power consumption under the power saving mode when an amount of write commands stores in the memory is less than a predetermined amount.

6. The disk array apparatus according to claim 5, wherein the controller detects a write command to the disk array apparatus.

7. The disk array apparatus according to claim 6, wherein the controller controls the storage units to have write data written into redundantly in response to a write command from the exterior after the storage units have been active state.

8. The disk array apparatus according to claim 5, wherein the controller controls either the storage unit which has been set the power saving mode to assume the inactive state or the storage unit which has been set the normal mode to assume an active state.

9. A disk array apparatus for storing data and allowing a host to read out and write into data by a command from the host, the disk array apparatus comprising:
a first and a second storage units for redundantly storing data and duplicate data, respectively;
a memory for storing data to be written into each of the first and second storage units; and
a controller for executing a process including:
controlling write data to be written into the first and the second storage units in duplicate in response to a write command from the host,
controlling at least one of the first and second storage units to produce read out data in response to a read command by the host while controlling the other of the first and second storage units to assume an inactive state, and
controlling the memory to temporarily store write data that is to be written into the first and second storage units in response to a write command, and while at least a part of the write data remains in the memory yet to be written into the first and second storage units, controlling one of the storage units to assume an inactive state to reduce power consumption and controlling the other of the first and second storage units to produce read out data in response to a read command subsequently issued by the host.
